(19) United States
(12) Patent Application Publication
(10) Pub. No.: US 2019/0197211 A1
(43) Pub. Date: Jun. 27, 2019

(54) METHOD FOR ESTIMATING STRESS INTENSITY FACTORS AND METHOD FOR CALCULATING ASSOCIATED SERVICE LIFE

(71) Applicant: SAFRAN AIRCRAFT ENGINES, Paris (FR)

(72) Inventors: Raulé Fernando DE MOURA PINHO, Moissy-Cramayel (FR); Didier José Diego SORIA, Moissy-Cramayel (FR)

(73) Assignee: SAFRAN AIRCRAFT ENGINES, Paris (FR)

(21) Appl. No.: 16/311,320

(22) PCT Filed: Jun. 20, 2017
(86) PCT No.: PCT/FR2017/051633

§ 371 Date: Dec. 19, 2018

(30) Foreign Application Priority Data
Jun. 20, 2016 (FR) 1655705

(51) Int. Cl. G06F 17/50

(52) U.S. Cl. CPC G06F 17/5018; G06F 17/5095; G01N 3/00; G01N 2203/0214; G06F 2217/16

(57) ABSTRACT

The invention relates to a method for estimating (100) stress intensity factors (FIC) in a numerically modelled part, in the context of a fatigue crack propagation model, comprising the following steps: —(E2): obtaining, from a numerical model of the part to be analysed (20), a plurality of values simulated at various points of the part to be analysed (20), —(E3): determining a converted value (ΔK) of the effective stress intensity amplitude corresponding to a straight front of a planar crack, as well as a converted length (a) of the crack corresponding to a planar crack with a straight front, said converted values being determined by equalisation of the energy dissipated in the three-dimensional crack of the numerical model and the energy dissipated in the crack of a standard model of a planar crack with a straight front, —(E4): interpolating converted values of effective stress intensity factor amplitude between two successive converted lengths (a), —(E5): storing the converted values of effective stress intensity factor amplitude interpolated in this way.

### GENERAL TECHNICAL FIELD

The invention relates to crack propagation analysis in mechanical parts. These parts are mainly intended for aircraft, but may be any mechanical component. Propagation is defined within a context of propagation by fatigue, with a series of loading cycles.

In particular, the invention relates to methods and systems for simulating, determining and interpolating the stress intensity factor (hereafter referred to as SIF) of a numerically modeled part to be analyzed. The invention also relates to methods and systems for calculating the service life of the part to be analyzed.

The SIF breaks down into three magnitudes, denoted by KI, KII and KIII, corresponding to the crack opening, plane shear and anti-plane shear modes, respectively.

The present description will be given for KI but is applicable to the other magnitudes.

Numerical crack propagation methods are very effective. For example, extended finite element (XFEM) or compliant cracking methods make it possible to reliably forecast crack propagation paths and calculate the SIFs along a crack front.

However, calculating service life in crack propagation is not generally incorporated in commercial codes or is incompatible with industrial requirements.

This is why the aeronautical industries normally develop their own code for calculating service life, the operation of which is based on specific post-processing of the results from numerical simulations of crack propagation.

For a given crack size and at a given point of the crack front, the SIF is the magnitude characterizing the intensity of the loading in the vicinity of the crack tip. The crack will be propagated more or less quickly according to the amplitude of this magnitude in the course of a fatigue loading cycle.

It is the role of numerical simulations of crack propagation to provide the values of the SIF along the crack front and for different lengths of crack.

From this list of values, the service life calculation codes must be able to predict service life in terms of crack propagation.

Nevertheless, for reasons of calculation capacity, the propagation increments, i.e. iterations of the numerical simulation calculations, are not taken too small, which means that not all the crack lengths are simulated.

In order to successfully perform the service life calculation, the SIFs must therefore be interpolated between the simulated propagation increments. It is therefore essential to have an effective interpolation method in order for the predicted service lives to be relevant.

### PRIOR ART

It is recalled that the present case falls within the context of a fatigue crack model, i.e. a model of the evolution of a crack when multiple loading cycles are applied.

3D cracking methods, generally obtained by finite elements, make it possible to obtain the SIFs along a crack front at each propagation increment as well as the geometric information that characterizes it (coordinates of the nodes of the crack front and faces and nodes associated with one of the faces of the crack). In practice, only the maximum SIF along the crack front for each propagation increment (see in FIG. 1 the single point P1, P2, P3, P4 on each of the curved lines representing each crack front F1, F2, F3, F4 with a different propagation increment) is involved in calculating the service life. In order to be able to use these SIF values, it is useful to match them with a corresponding crack length.

Subsequently, the points between each tabulated value are obtained using a linear interpolation between the tabulation points.

There are two major drawbacks regarding this method of interpolating SIFs.

The first relates to the fact that the SIF identified in the form is the maximum SIF along the crack front for each propagation increment. In other words, it is not necessarily the SIF corresponding to the same point of the front that is identified (the points in FIG. 1 involve different places in the crack front). Thus, with this method, no account is taken of the three-dimensional geometry of the crack and its evolution over time, which necessarily impacts the evolution of the SIF.

The second drawback relates to the fact that this method does not allow checking whether the propagation increment is sufficiently fine. It has been shown that if the propagation increment is too coarse, the crack propagation service lives may not be conservative.

There is also a final weakness in this approach relating to the geometry of the crack that must be considered, which may be complex (e.g. bifurcation). Indeed, the crack is an intrinsically three-dimensional construction and the problem is presented of defining the “length of the crack”. This severely limits the applicability of this method.

There are theoretical methods for calculating the propagation of cracks.

For example, the weight functions method may be used to calculate stress intensity factors SIF from the stress field of the non-cracked structure and the crack geometry (references [1], [2] and [3], for example—the references are given at the end of the description). Nevertheless, this method is limited to simple cases which makes it unusable as a general rule.

“Interference” methods are more complex mathematically speaking, but make it possible to semi-analytically determine cracking behavior and the stability of the front (see reference [4]). However, most of the developments only apply on the assumption of an at least semi-infinite medium.

### DESCRIPTION OF THE INVENTION

The invention thus provides a method for estimating the stress intensity factor in a numerically modeled part, within the context of a fatigue crack propagation model, comprising the following steps:
(E2): obtaining from a numerical model of the part to be analyzed, a plurality of values simulated at different points of the part to be analyzed, said plurality of simulated values comprising, for different simulated propagation increments of a three-dimensional crack which appears on the numerical model of the part, a set of simulated values of the stress intensity factor at associated points, the position of these points, and data relating to the cracked surface (coordinates of the nodes and faces of the three-dimensional elements defining one of the faces of the crack, the faces of the elements being able to be stored in the form of a connectivity table),
(E3): determining, for each propagation increment and for the set of simulated values therefor, a converted amplitude value of the equivalent global effective stress intensity factor corresponding to that of a plane crack with a straight front and a converted length of the equivalent crack considered, said converted values being determined by equalizing the energy dissipated in the three-dimensional crack of the numerical model and the energy dissipated in the crack of a standard model of a plane crack with a straight front, the energies themselves being determined according to the stress intensity factors,
(E4): Interpolating converted amplitude values of equivalent global effective stress intensity factor between two successive converted crack lengths (a),
(E5): Storing the converted amplitude values of equivalent global effective stress intensity factor thus interpolated with the associated crack lengths.

Thus, it relates to a global method “thermodynamically” equivalent to that of a plane crack with a straight front. A concept of length having a physical meaning is generated, which helps overcome the limitations mentioned previously.

The method described is implemented by a system comprising a data processing unit.

The invention also relates to the following features, taken alone or in combination:
the interpolation step implements a piecewise linear interpolation,
the interpolation step implements an interpolation by curvature energy minimization,
the interpolation step comprises the following substeps:
   interpolation using a linear interpolation,
   interpolation using an interpolation by curvature energy minimization, the two interpolations being interchangeable,
   calculation of at least one magnitude representative of a difference in amplitude values of the stress intensity factor between the two interpolations, said difference being calculated strictly between two values of lengths of the crack corresponding to two successive increments,
   comparison of said magnitude representative of the difference with a predetermined threshold,
   if the magnitude representative of the difference is above the threshold, generation of an instruction to calculate from the numerical simulation of the part to be analyzed stress intensity factor (SIF) values along the new simulated front and values of the position of the crack, between the two successive increments,
the method comprises, prior to the step of obtaining (E2), a step of calculating (E1) implementing the finite element (or extended finite element) simulation at successive increments of the evolution of the crack in the part to be analyzed, said simulation being performed by the processing unit,
the numerical data retrieved in obtaining (E2) the data are obtained by means of a finite element simulation or by an extended finite element simulation,
for the step of determining (E3), the first data subset makes it possible to find the effective amplitude of the energy release rate ΔG via the following relationships:

$$G = \frac{1}{{E}^{*}} ( {K}_{I}^{2} + {K}_{II}^{2} ) + \frac{1}{μ} {K}_{III}^{2}$$

$${E}^{*} = E in plane stresses$$

$${E}^{*} = E \text{/} ( 1 - {υ}^{2} ) in plane {strains \\ ( Δ {K}_{eff} ( s ) )}^{2} = Δ {G}_{eff} ( s ) . {E}^{*}$$

Where K_{I}, K_{II} and K_{III} are the SIF coefficients corresponding to the crack opening, plane shear and anti-plane shear modes, respectively, ΔK_{eff}(s) is the amplitude of the effective stress intensity factor, ΔG_{eff} is the amplitude of the effective energy release rate, s is the curvilinear abscissa along the crack front, E is Young's modulus, μ is the shear modulus, E* is the equivalent Young's modulus, ν is Poisson's ratio,

the second data subset makes it possible to find the cracked surface increment per unit of crack front length dSurf,

these formulations make it possible to obtain the value of the dissipated energy:

Dissipated energy=∫_{crack front}ΔG_{eff}(s)·dSurf(s)·dl

wherein this dissipated energy is equalized with the dissipated energy of the crack of a standard model of plane crack with a straight front, being expressed in the form:

Dissipated energy^{glob}=ΔG_{eff}^{glob}·dSurf^{glob}·L_{front}

Where the notation glob relates to this standard model, and L_{front} is the length of the crack front,

wherein, thanks to modeling using a Paris law with the Elber crack closure parameters, the link is made between dSurf^{glob} and ΔG_{eff}^{glob}

$$\frac{{dSurf}^{glob}}{dN} = C . {( \sqrt{Δ {G}_{eff}^{glob} . {E}^{*}} )}^{n}$$

Where C and n are Paris coefficients,

wherein, by equalizing the two dissipated energies, the following is obtained

$$Δ {G}_{eff}^{glob} = {( \frac{{\int }_{crack front} Δ {G}_{eff} ( s ) . dSurf ( s ) . dl}{C . {( {E}^{*} )}^{n} {L}_{front}} )}^{\frac{1}{n + 1}} = {( \frac{Dissipated energy}{C . {( {E}^{*} )}^{n} {L}_{front}} )}^{\frac{1}{n + 1}}$$

wherein, by means of the relationships between ΔGeff and ΔKeff, ΔK_{eff}^{glob} is determined and wherein Surf^{glob} is determined, i.e. the converted length a of the equivalent crack.

In particular, the first data subset contains the stress intensity factor values at associated points on the crack front and their associated respective position, and the second data subset contains the data relating to the cracked surface.

The invention also relates to a method for evaluating the service life of a numerically modeled part, wherein a calculation is implemented of the service life of the part involving the converted amplitude values of equivalent global effective stress intensity factor interpolated as a function of an equivalent crack length according to a method as described previously.

The invention also relates to a system comprising a processing unit comprising calculation means and a memory, the unit being configured for implementing a method for estimating or a method for evaluating fatigue crack propagation service life as described previously.

The invention also relates to a computer program product configured for being implemented by a system as described previously, and comprising instructions for bringing about the implementation of a method for estimating or a method for evaluating service life as described previously.

### DESCRIPTION OF THE FIGURES

Other features, objects and advantages of the invention will emerge from the following purely illustrative and non-restrictive description, which must be read with reference to the appended drawings in which:

FIG. 1 illustrates a crack front for different propagation increments,

FIG. 2 illustrates a system for implementing the invention,

FIG. 3 illustrates a part to be analyzed,

FIG. 4 illustrates two methods and associated embodiments according to the invention,

FIG. 5 illustrates points converted equivalently with a plane crack with a straight front, from a three-dimensional crack, according to an energy equivalence theory by thermodynamic analysis,

FIG. 6 illustrates these same points with two interpolation methods: piecewise linear and curvature energy minimization,

FIG. 7 illustrates the evolution of the polynomial interpolation with the degree of the polynomial,

FIG. 8 schematically illustrates a plane crack with a straight front,

FIGS. 9a to 9c illustrate 1D shape functions from a generalization of finite elements and used for calculating curvature energy,

FIGS. 10 to 10c illustrate a change in representation for smoothing the metrics.

### DETAILED DESCRIPTION

Referring to FIG. 2, a system 10 for interpolating the value of stress intensity factors (SIF) K of a part to be analyzed 20, which is modeled numerically. As indicated in the introduction, the SIF K breaks down into three data KI, KII, KIII. The description will be given only for KI.

The part to be analyzed 20 is a part intended for aeronautics, for which it must be possible to estimate the service life. The part 10 is typically a compressor or turbine fan blade, an engine disk, a flange, an engine mounting, a housing as illustrated in FIG. 3. This list is illustrative, since for implementing the method, the type of part is not, however, involved.

The system 10 comprises a data processing unit 12, e.g. a computer or a server, having calculation means 14 configured for implementing a method that will be described in more detail below and, advantageously, having a memory 16. The calculation means 14 may, for example, be a processor, microprocessor, microcontroller, etc. type of computer. The memory 16 may be, for example, a hard disk, a “flash” memory or a delocalized, “cloud” type storage space.

The data processing unit 12 may also be suitable for implementing numerical simulations such as finite elements, of the part to be analyzed 20. Finite element simulation makes it possible to obtain, for each simulation increment, data relating to said part and to crack propagation.

In particular, it is possible to obtain for each propagation increment, the values of the SIF at associated points and the position of these points, generally along the crack front. The positions comprise, for example, the coordinates of the nodes of the mesh defining the crack front. It is possible to obtain data relating to the cracked surface: in addition to the node coordinates, the faces of the three-dimensional elements defining one among the faces of the crack. These data are stored in the form of a connectivity table, conventionally known as finite elements. Other data, such as the mesh of the cracked surface and of the front may also be obtained.

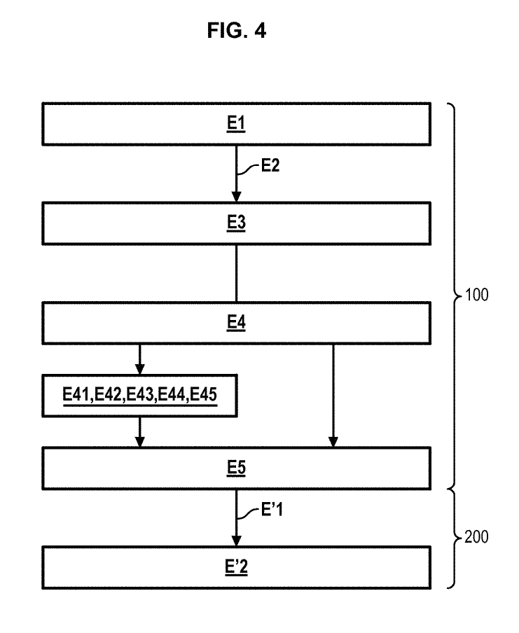

Referring to FIG. 4, a method 100 for interpolating the values of a SIF of a three-dimensional crack simulated by finite elements will be described.

This method 100 is also advantageously used for improving the interpolation of the SIF. This will be described later.

In a first step E1, a numerical simulation is performed on the part to be analyzed 10. This simulation makes it possible to obtain the aforementioned data.

In a preferred embodiment, this simulation is carried out by finite elements or extended finite elements.

This step E1 is performed either by the processing unit 12 of the system, or by another system.

In both cases, a step E2 of receiving said data (generated during step E1) by the processing unit 12 of the system is implemented. More precisely, for each simulated crack front a first data subset is defined containing the values of the SIF at the associated points on the crack front and their associated respective position, and a second data subset containing the data relating to the cracked surface (the node coordinates defining the crack front and the surface mesh of one of the faces of the crack, e.g. the connectivity table of the faces of the relevant three-dimensional elements) as they have been defined previously. Having a plurality of simulated fronts at different increments, a plurality of first and second data subsets is thereby obtained.

This is the first step of the interpolation method itself, insofar as the simulation step E1 is not necessarily implemented expressly for later interpolation.

In step E3, the problem of the geometry of the crack in three dimensions is reduced to a problem of a plane crack with a straight front. The plane crack with a straight front is a standard model known to the person skilled in the art. For this, a thermodynamic equivalence based on an equality of the dissipated energy between the two models is performed. The physical basis is explained below.

The first principle of thermodynamics, for a transformation of the infinitesimal crack front, expressed in energy density per unit length of crack front, gives:

$${\underbrace{{dW}_{el}^{i}}}_{\begin{matrix}internal energy \\ density\end{matrix}} = {\underbrace{δ Q}}_{heat density} + {\underbrace{δ {W}_{ext}}}_{\begin{matrix}density of work of \\ external forces\end{matrix}}$$

The second principle of thermodynamics makes it possible to express the irreversibility of the transformation:

$$T . dS = δ Q + {\underbrace{G . dSurf}}_{dissipated energy density}$$

The dissipated energy density is always positive. The term dSurf represents the increment of cracked surface per unit length of crack front in the course of the infinitesimal transformation. This quantity is homogeneous with a length: it is a kind of increment of length of crack in the “thermodynamic” sense of the term. It thus appears a “physical” magnitude that may be considered for interpolating which has a physical meaning.

The preceding elements allow the initial three-dimensional cracking problem to be made equivalent to a problem of propagation of a plane crack with a straight front in plane elasticity. More generally, the case of adapted elasticity is considered, i.e. the material has already been able to undergo plastic deformation initially, but crack propagation takes place under cyclic elastic fatigue loading.

The temperature field may evolve over time, but the temperature field does not vary spatially. Consequently, a fatigue cycle is associated with a temperature.

One modeling hypothesis consists in considering that the law of crack propagation is a Paris law with Elber correction (references [5], [6]), given by the following equation:

$$\frac{dSurf}{dN} = C ( T ) . {( Δ K . U ( R , T ) )}^{n ( T )} = C ( T ) . {( Δ {K}_{eff} )}^{n ( T )}$$

$$with U ( R , T ) = a ( T ) . R + b ( T )$$

where C(T) and n(T) are the coefficients of the Paris law and a(T) and b(T) are the parameters of Elber's crack closure law, ΔK is the amplitude of the SIF, which makes it possible to dispense with the load ratio (i.e. the ratio R=Kmin/Kmax) and ΔK_{eff} is the effective amplitude of the SIF, which takes into account the effect of the crack closure. The link between ΔK and ΔK_{eff} has been established by Elber.

The cracked surface increment dSurf per cycle is now connected to the amplitude of the effective stress intensity factor ΔK_{eff}.

There is a relationship between K (or ΔK_{eff}, by equivalence) and the energy release rate G (or the amplitude of said effective rate ΔG_{eff} by equivalence), given by the following relationships:

$$G = \frac{1}{{E}^{*}} ( {K}_{I}^{2} + {K}_{II}^{2} ) + \frac{1}{μ} {K}_{III}^{2}$$

$${E}^{*} = E in plane stresses$$

$${E}^{*} = E \text{/} ( 1 - {υ}^{2} ) in plane strains$$

where E is Young's modulus, E* is the equivalent Young's modulus, μ is the shear modulus, ν is Poisson's ratio.

The SIF is known at each point of the crack front and for each propagation increment using the numerical simulation of step E1 and retrieved in step E2.

By replacing the values with their amplitude in the preceding relationships, a relationship is obtained, by definition, between the energy release rate and the amplitude of the effective stress intensity factor (s being the curvilinear abscissa along the crack front):

(ΔK_{eff}(s))²=ΔG^{eff}(s)·E*

The energy dissipated in the course of the cracking process is obtained by the following relationship (by remaining in the infinitesimal transformation hypothesis, therefore considering only one loading cycle):

Dissipated energy=∫_{crack front}ΔG_{eff}(s)·dSurf(s)·dl

The dSurf is known using the data relating to the cracked surface calculated by the numerical simulation in step E1 and retrieved in step E2.

By postulating an equivalence of the 3D cracking problem with a problem of plane cracking with a straight front, the dissipated energies and the crack front lengths may be equalized. Consequently, it is legitimate to write:

Dissipated energy^{glob}=ΔG_{eff}^{glob}·dSurf^{glob}·L_{front}

The notation “glob” means that the datum is specific to the model in plane cracking with a straight front.

Plane cracking with a straight front also respects the Paris propagation law. Consequently, it is obtained that

$$\frac{{dSurf}^{glob}}{dN} = C . {( \sqrt{Δ {G}_{eff}^{glob} . {E}^{*}} )}^{n}$$

By equalizing the two dissipated energies and by rewriting the equation, the following relationship is obtained

$$Δ {G}_{eff}^{glob} = {( \frac{Dissipated energy}{C . {( {E}^{*} )}^{n} {L}_{front}} )}^{\frac{1}{n + 1}} = {( \frac{{\int }_{crack front} Δ {G}_{eff} ( s ) . dSurf ( s ) . dl}{C . {( {E}^{*} )}^{n} {L}_{front}} )}^{\frac{1}{n + 1}}$$

However, dSurf^{glob}/dN=dSurf^{glob} (because dN=1 here, since only a single cycle is considered) is homogeneous with a crack length. Consequently, its integration in the course of the time between the first cycle and the last cycle makes it possible to obtain an equivalent crack length Surf^{glob}, noted length a, in the thermodynamic sense. A length is actually obtained which has a physical meaning.

The previous relationship established between ΔK_{eff}^{glob} and ΔG_{eff}^{glob} makes it possible to inject the amplitude of the effective SIF into the preceding equation.

Thus a relationship is obtained connecting the amplitude of the equivalent global effective SIF in the modeling of the flat crack with a straight front as a function of the length of the crack Surf glob i.e. the length a. These data may then be interpolated.

This physical construction is valid in all generality. However, it requires knowing all the information of the problem for each loading cycle which is generally too costly in terms of calculation time and memory space for saving all the results (at least a thousand cycles should be simulated). The finite element calculations are often made with no fixed maximum propagation increment along the crack front, or pre-integrate over a given number of cycles (10, 100 or 1000, for example). This amounts to de-refining the discretization in propagation increment in order to reduce the calculation time.

Consequently, the propagation law is replaced by:

$$\frac{{dSurf}_{eq}^{glob}}{dN} = C . {coeff ( \sqrt{Δ {G}_{eff}^{glob} . {E}^{*}} )}^{n} = {C}_{eq} . {( \sqrt{Δ {G}_{eff}^{glob} . {E}^{*}} )}^{{n}_{eq}}$$

where coeff is the coefficient which allows the pre-integration of multiple cycles.

This amounts to modifying the coefficients of the Paris law C and n by the coefficients C_{eq}=C.coeff and n_{eq}=n. The link between dSurf_{eq}^{glob} and dSurf^{glob} is therefore the following:

dSurf_{eq}^{glob}=coeff·dSurf^{glob}

In addition, the term dSurf(s) is replaced by the incremented surface between two simulated propagation increments dSurf_{eq}(s) (therefore not infinitesimal).

In conclusion, the above reasoning applies approximately by performing the preceding substitutions, and the equivalent crack length is still deduced in the same way.

Thus, in step E3, from the plurality of first and second data subsets retrieved in step E2, i.e. the SIF data along the different fronts of simulated cracks at different increments and the data relating to the cracked surfaces, the means of which have been previously explained, the global effective amplitude of the SIF ΔK_{eff}^{glob} and the associated length a of the plane crack with a straight front are determined. This determination is implemented by the processing unit 12.

For a given crack front, the simulated data of the SIF make it possible to find K (first data subset) and using the preceding equations make it possible to calculate the ΔK_{eff}^{glob} and the cracked surface data dSurf_{eq} (second data subset) make it possible to calculate the length a. Due to the plurality of data corresponding to each front, a plurality of pairs (a, ΔK_{eff}^{glob}) is obtained.

The equivalence obtained may also be applied to a plane crack with a straight front. The following relationship shows that the system remains invariant:

$$\begin{matrix}Δ {G}_{eff}^{glob} = {( \frac{{\int }_{crack front} Δ {G}_{eff} ( s ) . {dSurf}_{eq} ( s ) . dl}{{C}_{eq} . {( {E}^{*} )}^{{n}_{eq}} . {L}_{front}} )}^{\frac{1}{{n}_{eq} + 1}} \\ = {( \frac{Δ {G}_{eff} . {C}_{eq} . {( Δ {G}_{eff} . {E}^{*} )}^{{n}_{eq}}}{{C}_{eq} . {( {E}^{*} )}^{{n}_{eq}}} )}^{\frac{1}{{n}_{eq} + 1}} \\ = Δ {G}_{eff}\end{matrix}$$

From this it follows that the cracked surfaces are the same, so that the final system is identical to the initial problem. This proves the consistency of the method based on a thermodynamic analysis of the problem.

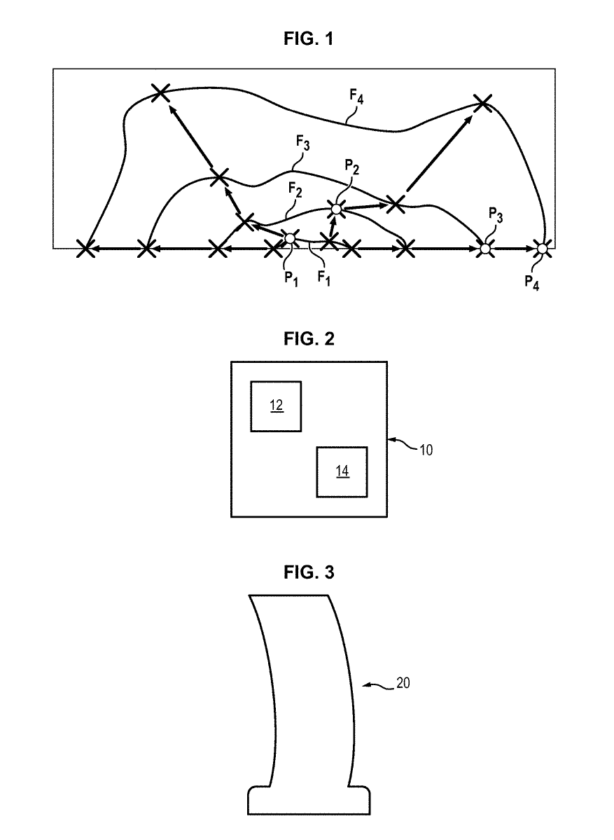

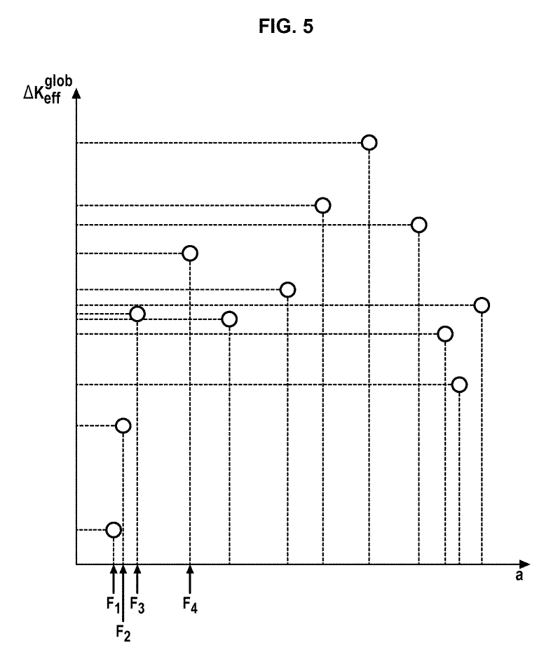

FIG. 5 illustrates the representation of the pairs (a, ΔK_{eff}^{glob}) in the plane. The references F1, F2, F3, F4 are given with reference to FIG. 1, for indicating to which front of the original crack the points of the graph correspond. This is a writing misuse.

It is recalled just now that the goal is to be able to determine SIFs for crack states that have not been numerically simulated, i.e. for states that occur strictly between two successive increments.

To this end, in a step E4, an interpolation of the ΔK_{eff}^{glob} as a function of the length a is performed. The interpolation is performed by the calculation means 14 of the processing unit 12.

The interpolation may be performed according to several methods. Interpolations are preferred which do not create information for the problem or whereby a minimum of information is added. For this, a piecewise linear interpolation IL or interpolation by curvature energy minimization IMC would be suitable. Both interpolations may also be performed, insofar as they may have different applications.

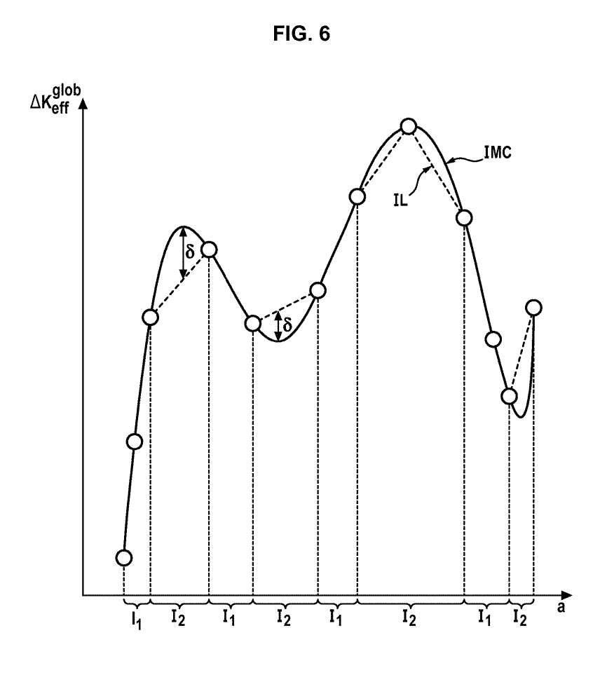

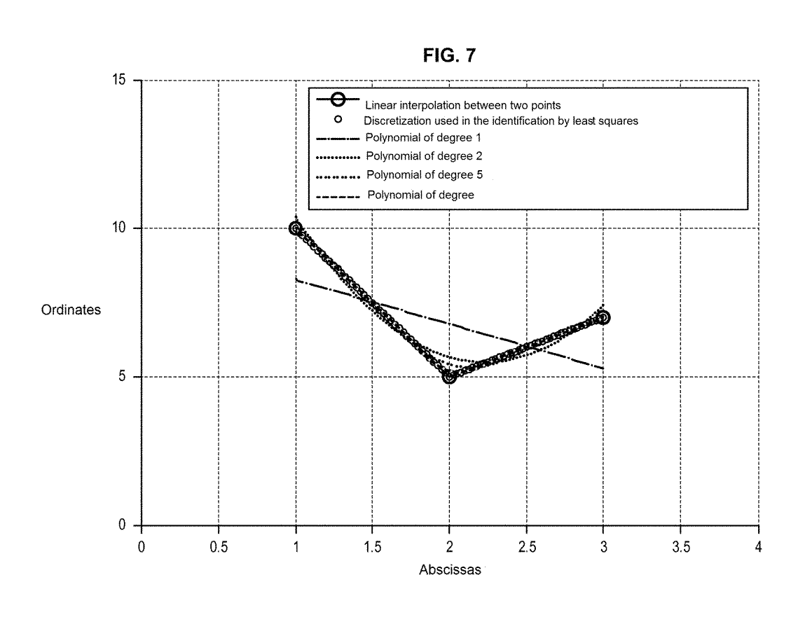

FIG. 6 illustrates these two interpolations.

Interpolation by global curvature energy minimization may be seen as a method based on physical considerations specific to the cracking problem. Indeed, the scientific literature on the subject shows that if a crack is propagated without branching, then the evolution of the stress intensity factor with crack extension may be represented by an infinitely differentiable function. This means that calculating the curvature of such a function is meaningful.

In addition, minimizing a curvature energy takes place in some physical situations such as, for example, in the physics of soap bubbles or more generally in the physics of membranes.

FIG. 7 illustrates a linear interpolation between three points. This example shows us that it is possible to improve on approximating an interpolation by polynomials. The higher the degree of the polynomial, the better the approximation will be. It is also possible to demonstrate that the maximum difference between linear interpolation and polynomial approximation tends toward zero when the degree of the polynomial tends toward infinity. Thus, linear interpolation may be seen as the passage to the limit at infinity that would be applied to an infinitely differentiable function.

This approach confers a “physical” character on both piecewise linear interpolation and interpolation based on curvature energy minimization.

Performing an interpolation consists in completing the missing information using a principle which should at least respect the “physics” of the problem considered, i.e. not introducing any elements that would violate certain fundamental equations that the problem obeys.

For this reason, interpolation by curvature energy minimization is a “physical” method because it does not contradict the theory of fracture mechanics. The method consisting of piecewise linear interpolations is not initially physical but may be seen as the passage to the limit of a method of global polynomial interpolation, which would be physical and by extension would make the piecewise linear interpolation method almost “physical” too.

Another point of view regarding the method of linear interpolation would be to see it as a method of minimizing the distance between points. This way of seeing things then places it in the category of optimal methods. Linear interpolation minimizes the distance while the other minimizes the curvature energy under the position constraints of the points to be connected. Minimizing distances may be seen as a means of connecting points without introducing additional information to the initial problem, and this results in a continuous field. In the case of the second method, at least one additional piece of information is introduced, which is that the field is regular. In this case, curvature energy minimization is an optimal method in the sense that the physical information to be introduced is minimized whereas the linear interpolation method is optimal in the sense that the purely mathematical information is minimized.

Finally, in a step E5, after the interpolation step, the interpolated data are stored, in order that other applications may have access thereto. Storage typically takes place in the memory 16. It is generally referred to as a “form”. The form is a table that gives the stress intensity factors as a function of the length of the crack.

Consequently, the interpolation step E4 generates a file, in the form of a text or a table containing the form, i.e. combining the converted data and the interpolated converted data. Step E5 consists in storing this file.

Indeed, as indicated in the introduction, obtaining the form is generally used for calculating the service life of a part. Consequently, with reference to FIG. 4, a method 200 is described for determining the service life of the part to be analyzed 20.

In a step E′1, the processing unit 12 receives the form calculated in step E4 and/or stored in step E5 of the preceding method. This retrieval step may simply consist in having access to the memory 16.

In a step E′2, a method is implemented for calculating the fatigue crack propagation service life of the part. Document [7] describes such a method.

It is sufficient to use an existing code and replace the SIF form with that provided in this invention for determining the crack propagation service life.

This method 200 may be implemented by a system other than that described previously.

### Error Refinement

When all of the information is available concerning the problem to be resolved, the result of interpolation will always be the same regardless of the interpolation method used and which meets all “physical” constraints of the problem. Typically, over the intervals I1 in FIG. 6, the interpolation intuitively appears to be of good quality; over the I2 intervals, it intuitively appears to be of lower quality.

It is thus possible to see the differences between two “physical and or mathematical” optimal interpolations as a means of identifying a lack of information that would be useful for improving the interpolation or the degree of confidence in the interpolation.

This consideration helps set up a step of checking relevance, illustrated in FIG. 6.

In two interchangeable substeps E41 and E42 of interpolation, a linear piecewise interpolation and curvature energy interpolation are performed.

It is noted that strictly between two length values corresponding to two simulated successive increments, i.e. strictly in an interpolated area, there are differences δ in value ΔK_{eff}^{glob} between the two interpolations.

In a substep E43, at least one of these differences δ is calculated, which is compared, in a substep E44, to a predetermined threshold value VSP.

The predetermined threshold VSP is selected according to the desired quality of the interpolation.

It is also possible to compare a value of these differences for each area between two successive increments, or to compare an average or a maximum value, etc. Thus a magnitude δr representative of the difference will be referred to more generally. This magnitude, δr indicates that there is a difference that could be quantified by the functions mentioned previously.

Finally, a substep of comparison E45 between the representative magnitude δr and the threshold VSP is performed.

If the representative magnitude δr is below the threshold VSP, it may be considered that the two interpolations are of good quality and that the data, if they had been simulated, would be close to the two interpolation values.

If the representative magnitude δr is above the threshold VSP, then it may be considered that there is too much uncertainty regarding the interpolation, and obtaining new simulated values is useful, or even necessary. To this end, a calculation instruction is generated from the numerical simulation, typically by finite elements (or extended finite elements) of the part to be analyzed 20 of at least a value of the stress intensity factor SIF and the position of the crack front between the two successive increments. In other words, the processing unit 12 sends an instruction to perform a part of step E1, with a reduced increment for at least one simulation.

This is referred to as refinement of the discretization in crack length.

By way of example, a predetermined threshold value VSP of 2% may be suitable. The criterion depends on the specifications.

It may be decided, for example, that δr=5 and that as soon as δr/max

(ΔK_{eff}^{glob} among linear and curvature interpolation)>2% for a given value of length a, an instruction for recalculating the simulation is generated.

Finally, the step of storing E5 may comprise the storing of both the interpolations and the representative magnitudes of the differences δr and/or the differences δ.

### Appendix 1: Example of Interpolation by Curvature Energy Minimization

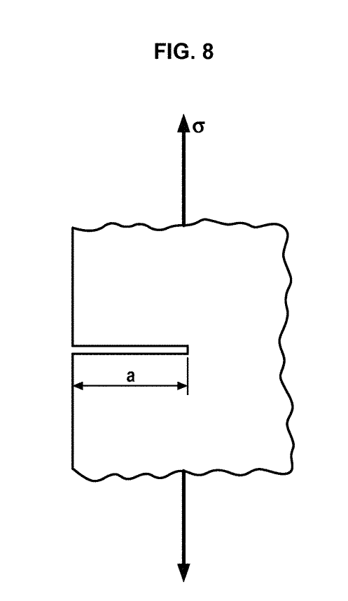

Interpolation by curvature energy minimization only gives consistent physical predictions within the context of a plane crack with a straight front in plane elasticity, as illustrated in FIG. 8, where σ represents the stress, and a the length of the crack. However, the method described previously makes it possible to thermodynamically consider any three-dimensional crack as a crack satisfying these properties.

To perform this interpolation, the curvature energy has to be determined.

The function f is defined in the following way (x is the “virtual” crack length, previously referred to as a):

$$\frac{{dK}_{I}}{dx} = f ( x )$$

The need to introduce “virtual” crack lengths is explained in APPENDIX 2.

The function f is written as a linear combination of the piecewise reference polynomial functions (of degree 5 for ensuring a regularity C2 over the whole evolution range of the “virtual” crack length, which involves a generalization of the conventional finite elements) given below:

$$\{ \begin{matrix}{C}_{1 , 1} ( z ) = 0 , 5 - 0.9375 . z + 0 , 625. {z}^{3} - 0 , 1875. {z}^{5} \\ {C}_{1 , 2} ( z ) = 2. ( \begin{matrix}0 , 3125 - 0.4375 . z - 0.375 . {z}^{2} + \\ 0 , 625. {z}^{3} + 0 , 0625. {z}^{4} - 0 , 1875. {z}^{5}\end{matrix} ) \\ {C}_{1 , 3} ( z ) = 4 ( \begin{matrix}0 , 0625 - 0.0625 . z - 0.125 . {z}^{2} + \\ 0 , 125 {z}^{3} + 0 , 0625. {z}^{4} - 0 , 0625. {z}^{5}\end{matrix} ) \\ {C}_{2 , 1} ( z ) = 0 , 5 + 0.9375 . z - 0 , 625. {z}^{3} + 0 , 1875. {z}^{5} \\ {C}_{2 , 2} ( z ) = 2. ( \begin{matrix}- 0 , 3125 - 0.4375 . z + 0.375 . {z}^{2} + \\ 0 , 625. {z}^{3} - 0 , 025. {z}^{4} = 0 , 1875. {z}^{5}\end{matrix} ) \\ {C}_{2 , 3} ( z ) = 4. ( \begin{matrix}0 , 0625 + 0.0625 . z - 0.125 . {z}^{2} - \\ 0 , 125. {z}^{3} + 0 , 0625. {z}^{4} + 0 , 0625. {z}^{5}\end{matrix} ) \\ z = \frac{x - {x}^{j + 1}}{{x}^{j + 1} - {x}^{j}} + \frac{x - {x}^{j}}{{x}^{j + 1} - {x}^{j}}\end{matrix}$$

The first index indicates the number of the node on which the nodal value is taken.

The second index indicates the nature of the nodal value:

1: Nodal value of the stress intensity factor (SIF)
2: Nodal value of the derivative with respect to the variable z of the SIF
3: Nodal value of the second derivative with respect to the variable z of the SIF

The one-dimensional element associated with these shape functions is defined so that the first node is located at z=−1 and the second at z=1.

The curvilinear abscissa associated with the curve giving the evolution of the stress intensity factor as functions of the “virtual” crack length is given by:

$$\begin{matrix}s ( x ) = {\int }_{{x}_{1}}^{x} \sqrt{( 1 + {( f ( u ) )}^{2} )} \cdot du \\ = {\sum }_{i = 1}^{j - 1} {\int }_{{x}_{1}}^{{x}_{i + 1}} \sqrt{( 1 + {( f ( u ) )}^{2} )} \cdot du + \\ {\int }_{{x}_{j}}^{x} \sqrt{( 1 + {( f ( u ) )}^{2} )} \cdot du\end{matrix}$$

$$It will be noted \text{:}$$

$$\{ \begin{matrix}z = \frac{x - {x}^{j + 1}}{{x}^{j + 1} - {x}^{j}} + \frac{x - {x}^{j}}{{x}^{j + 1} - {x}^{j}} \\ f ( x ) = {f}^{j} ( z ) = {f}_{11}^{j} \cdot {C}_{1 , 1} ( z ) + {f}_{12}^{j} \cdot {C}_{1 , 2} ( z ) + \\ {f}_{13}^{j} \cdot {C}_{1 , 3} ( z ) + {f}_{11}^{j + 1} \cdot {C}_{2 , 1} ( z ) + {f}_{12}^{j + 1} + {C}_{2 , 2} ( z ) + \\ {f}_{13}^{j + 1} \cdot {C}_{2 , 3} ( z )\end{matrix}$$

It will be noted that the degrees of freedom f₁₁^{j} and f₁₁^{j+1}=f₂₁^{j} are known. Optimization will focus on the other degrees of freedom.

Whence the following is obtained (where Lₓ is the length of the virtual element):

$${s}_{x} ( x ) = ( {\sum }_{i = 1}^{j - 1} {\int }_{- 1}^{1} \sqrt{( 1 + {( {f}^{i} ( z ) )}^{2} )} \cdot dz + {\int }_{- 1}^{z} \sqrt{( 1 + {( {f}^{j} ( z ) )}^{2} )} \cdot du ) \cdot \frac{{L}_{x}}{2}$$

The unit tangent vector is obtained as follows:

$$t ( {s}_{x} ) = \frac{{dK}_{I}}{{ds}_{x}} ( {s}_{x} )$$

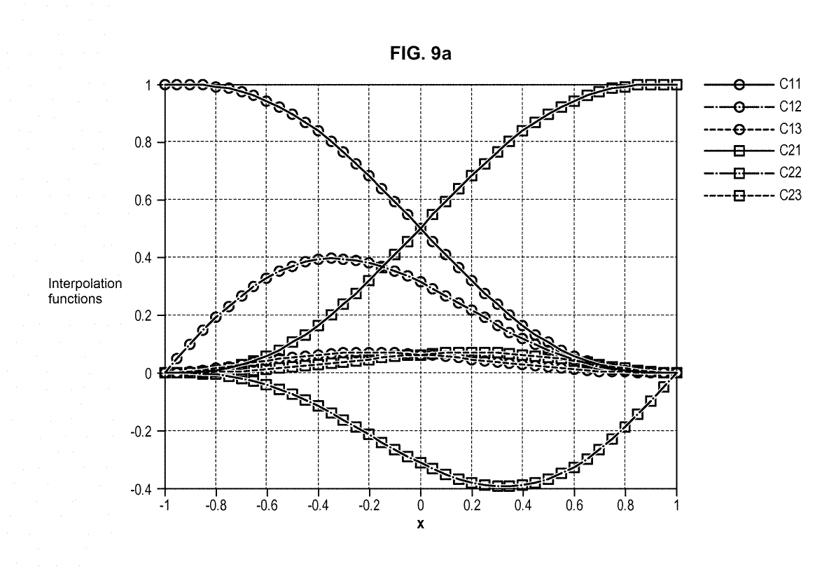

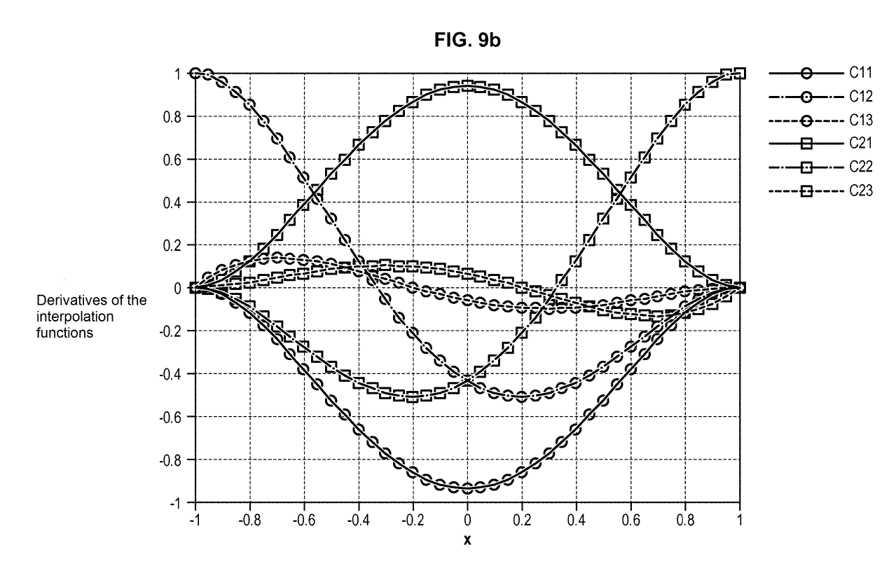

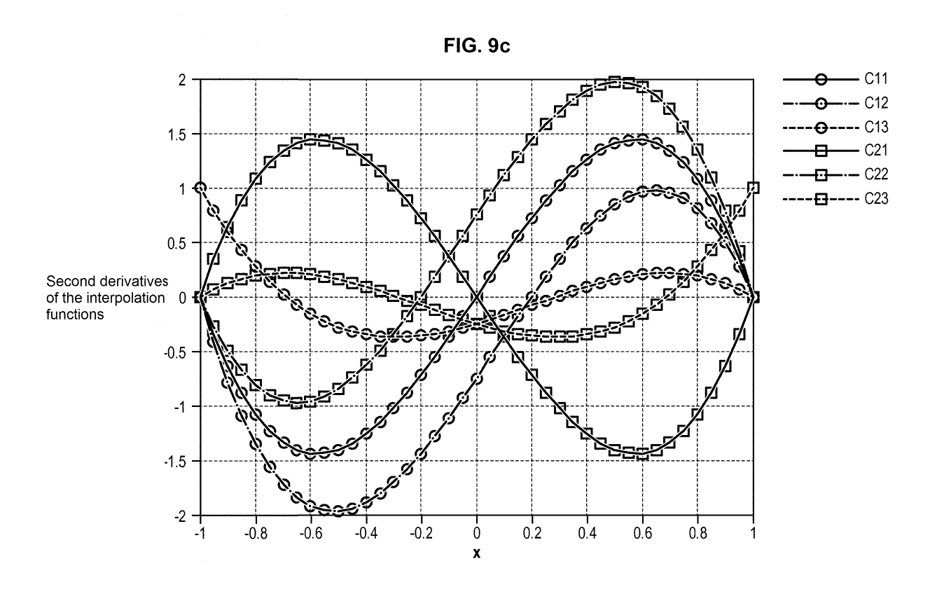

FIGS. 9a to 9c illustrate the values of the shape functions C11, C12, C13, C21, C22 and C23 and their derivative and second derivative. It is noted that these curves satisfy their specific constraints (0 or 1) at the nodes.

The unit tangent vector to the curve K_{I} may now be calculated. The formulae given previously lead to:

$$\begin{matrix}{t}_{x} = \frac{d {γ}_{x}}{{ds}_{x}} = \frac{d {γ}_{x}}{dx} \cdot \frac{dx}{{ds}_{x}} \\ = ( \begin{matrix}1 \\ f ( x )\end{matrix} ) \cdot \frac{1}{\frac{{ds}_{x}}{dz} \cdot \frac{dz}{dx}} \\ = ( \begin{matrix}1 \\ f ( x )\end{matrix} ) \cdot {[ 1 + {( {f}^{j} ( \frac{x - {x}^{j + 1}}{{x}^{j + 1} - {x}^{j}} + \frac{x - {x}^{j}}{{x}^{j + 1} - {x}^{j}} ) )}^{2} ]}^{- \frac{1}{2}}\end{matrix}$$

All that remains is the calculation of the curvature. For this, the derivative of tₓ is calculated with respect to the curvilinear abscissa:

$$\begin{matrix}\frac{{dt}_{x}}{{ds}_{x}} = \frac{d}{{ds}_{x}} ( \frac{d {γ}_{x}}{dx} \cdot \frac{dx}{{ds}_{x}} ) \\ = \frac{{d }^{2} {γ}_{x}}{{dx}^{2}} \cdot {( \frac{dx}{{ds}_{x}} )}^{2} + \frac{d {γ}_{x}}{dx} \cdot \frac{{d}^{2} x}{{d ( {s}_{x} )}^{2}} \\ = ( \begin{matrix}0 \\ {f}^{′} ( x )\end{matrix} ) \cdot {( \frac{dx}{{ds}_{x}} )}^{2} + ( \begin{matrix}1 \\ f ( x )\end{matrix} ) \cdot \frac{{d}^{2} x}{{d ( {s}_{x} )}^{2}}\end{matrix}$$

For determining the derivative terms with respect to the curvilinear abscissa, the formulae for differential passage from the curvilinear coordinate to the virtual coordinate are expressed:

$$( \begin{matrix}\frac{d}{{ds}_{x}} \\ \frac{{d}^{2}}{{d ( {s}_{x} )}^{2}}\end{matrix} ) = {\underbrace{[ \begin{matrix}\frac{dx}{{ds}_{x}} & 0 \\ \frac{{d}^{2} x}{{d ( {s}_{x} )}^{2}} & {( \frac{dx}{{ds}_{x}} )}^{2}\end{matrix} ]}}_{{Diff}_{{s}_{x}}} \cdot ( \begin{matrix}\frac{d}{dx} \\ \frac{{d}^{2}}{{dx}^{2}}\end{matrix} )$$

This matrix equation is invertible, which makes it possible to obtain:

$$( \begin{matrix}\frac{d}{dx} \\ \frac{{d}^{2}}{{dx}^{2}}\end{matrix} ) = {\underbrace{[ \begin{matrix}\frac{{ds}_{x}}{dx} & 0 \\ \frac{{d}^{2} {s}_{x}}{{dx}^{2}} & {( \frac{{ds}_{x}}{dx} )}^{2}\end{matrix} ]}}_{{Diff}_{{s}_{x}}} \cdot ( \begin{matrix}\frac{d}{{ds}_{x}} \\ \frac{{d}^{2}}{{d ( {s}_{x} )}^{2}}\end{matrix} )$$

It is noted that Diffₓ⁻¹=Diffₛ_{ₓ}, which makes it possible to easily determine

$${( \frac{{ds}_{x}}{dx} )}^{2} and \frac{{ds}_{x}}{dx} .$$

Finally, it is found that:

$$\frac{{dt}_{x}}{{ds}_{x}} = ( \begin{matrix}0 \\ {f}^{′} ( x )\end{matrix} ) \cdot {Diff}_{x}^{- 1} ( 2 , 2 ) + ( \begin{matrix}1 \\ f ( x )\end{matrix} ) \cdot {Diff}_{x}^{- 1} ( 2 , 1 )$$

$$With \text{:}$$

$${Diff}_{x} = [ \begin{matrix}\frac{{ds}_{x}}{dx} & 0 \\ \frac{{d}^{2} {s}_{x}}{{dx}^{2}} & {( \frac{{ds}_{x}}{dx} )}^{2}\end{matrix} ]$$

The curvature is automatically deduced therefrom:

$$κ ( x ) = \sqrt{{( {Diff}_{x}^{- 1} ( 2 , 1 ) )}^{2} + {( {f}^{′} ( x ) . {Diff}_{x}^{- 1} ( 2 , 2 ) + f ( x ) . {Diff}_{x}^{- 1} ( 2 , 1 ) )}^{2}}$$

The matrix Diffₓ⁻¹ must now be explained. For this, the following conventional 2×2 matrix inversion formula is used:

$$A = ( \begin{matrix}a & b \\ c & d\end{matrix} ) ⇒ {A}^{- 1} = \frac{1}{det ( A )} \cdot ( \begin{matrix}d & - b \\ - c & a\end{matrix} ) with$$

$$det ( A ) = a . d - b . c$$

$$Hence \text{:}$$

$$\{ \begin{matrix}z = \frac{x - {x}^{j + 1}}{{x}^{j + 1} - {x}^{j}} + \frac{x - {x}^{j}}{{x}^{j + 1} - {x}^{j}} \\ det ( {Diff}_{x} ) = {( \frac{{ds}_{x}}{dx} )}^{3} = {[ 1 + {( {f}^{j} ( z ) )}^{2} ]}^{3} \\ {Diff}_{x}^{- 1} ( x ) = \frac{1}{det ( {Diff}_{x} )} \cdot [ \begin{matrix}{[ 1 + {( {f}^{j} ( z ) )}^{2} ]}^{2} & 0 \\ - \frac{4}{{L}_{x}} \cdot {f}^{j} ( z ) \cdot \frac{{df}^{j}}{dz} ( z ) & 1 + {( {f}^{j} ( z ) )}^{2}\end{matrix} ]\end{matrix}$$

The functional that it is sought to minimize is the following (if the mesh consists of n−1 element):

Wₓ=∫ₓ_{₁}^{x}^{ₙ}{square root over ((1+(f(u))²))}·(κ(u))²·du

Preferably a Newton algorithm is then used for determining the parameters fᵢⱼ^{k} that minimize this functional. It is thus necessary to know the gradient vectors and Hessian matrices (with respect to the unknown variables) of the magnitudes involved in the optimization problem.

$$\{ \begin{matrix}{Grad ( {κ ( u )}^{2} )}_{i} = [ \begin{matrix}2. ( {Diff}_{x}^{- 1} ( 2 , 1 ) ) . {Grad ( {Diff}_{x}^{- 1} ( 2 , 1 ) )}_{i} + \\ 2. ( {f}^{′} ( x ) . {Diff}_{x}^{- 1} ( 2 , 2 ) + f ( x ) . {Diff}_{x}^{- 1} ( 2 , 1 ) ) \cdot \\ ( \begin{matrix}{Grad ( {f}^{′} ( x ) )}_{i} . {Diff}_{x}^{- 1} ( 2 , 2 ) + {f}^{′} ( x ) . {Grad ( {Diff}_{x}^{- 1} ( 2 , 2 ) )}_{i} + \\ {Grad ( f ( x ) )}_{i} . {Diff}_{x}^{- 1} ( 2 , 1 ) + f ( x ) . {Grad ( {Diff}_{x}^{- 1} ( 2 , 1 ) )}_{i}\end{matrix} )\end{matrix} ] \\ {H ( {κ ( u )}^{2} )}_{i} = [ \begin{matrix}2. Grad ( {Diff}_{x}^{- 1} ( 2 , 1 ) ) \cdot {Grad ( {Diff}_{x}^{- 1} ( 2 , 1 ) )}_{i} + \\ 2. ( {Diff}_{x}^{- 1} ( 2 , 1 ) ) . {H ( {Diff}_{x}^{- 1} ( 2 , 1 ) )}_{ij} + \\ 2. ( \begin{matrix}{Grad ( {f}^{′} ( x ) )}_{j} . {Diff}_{x}^{- 1} ( 2 , 2 ) + {f}^{′} ( x ) . {Grad ( {Diff}_{x}^{- 1} ( 2 , 2 ) )}_{j} \\ {Grad ( f ( x ) )}_{j} . {Diff}_{x}^{- 1} ( 2 , 1 ) + f ( x ) . {Grad ( {Diff}_{x}^{- 1} ( 2 , 1 ) )}_{j}\end{matrix} ) \cdot \\ ( \begin{matrix}{Grad ( {f}^{′} ( x ) )}_{i} . {Diff}_{x}^{- 1} ( 2 , 2 ) + {f}^{′} ( x ) . {Grad ( {Diff}_{x}^{- 1} ( 2 , 2 ) )}_{i} + \\ {Grad ( f ( x ) )}_{i} . {Diff}_{x}^{- 1} ( 2 , 1 ) + f ( x ) . {Grad ( {Diff}_{x}^{- 1} ( 2 , 1 ) )}_{i}\end{matrix} ) + \\ 2. ( {f}^{′} ( x ) . {Diff}_{x}^{- 1} ( 2 , 2 ) + f ( x ) . {Diff}_{x}^{- 1} ( 2 , 1 ) ) \\ ( \begin{matrix}{H ( {f}^{′} ( x ) )}_{ij} \cdot {Diff}_{x}^{- 1} ( 2 , 2 ) + {Grad ( {f}^{′} ( x ) )}_{i} . {Grad ( {Diff}_{x}^{- 1} ( 2 , 2 ) )}_{j} + \\ {Grad ( {f}^{′} ( x ) )}_{j} . {Grad ( {Diff}_{x}^{- 1} ( 2 , 2 ) )}_{i} + {f}^{′} ( x ) . {H ( {Diff}_{x}^{- 1} ( 2 , 2 ) )}_{ij} \\ {H ( f ( x ) )}_{ij} \cdot {Diff}_{x}^{- 1} ( 2 , 1 ) + {Grad ( f ( x ) )}_{i} . {Grad ( {Diff}_{x}^{- 1} ( 2 , 1 ) )}_{j} + \\ {Grad ( f ( x ) )}_{j} . {Grad ( {Diff}_{x}^{- 1} ( 2 , 1 ) )}_{i} + f ( x ) . {H ( {Diff}_{x}^{- 1} ( 2 , 2 ) )}_{ij}\end{matrix} )\end{matrix} ]\end{matrix} \\ \{ \begin{matrix}{Grad ( {W}_{x} )}_{i} = ( \begin{matrix}{\int }_{{x}_{1}}^{{x}_{n}} {( 1 + {( f ( u ) )}^{2} )}^{\frac{1}{2}} . {Grad ( f ( u ) )}_{i} . {( κ ( u ) )}^{2} . du + \\ 2. {\int }_{{x}_{1}}^{{x}_{n}} \sqrt{( 1 + {( f ( u ) )}^{2} )} . {Grad ( {κ ( u )}^{2} )}_{i} du\end{matrix} ) \\ {H ( {W}_{x} )}_{ij} = ( \begin{matrix}- {\int }_{{x}_{1}}^{{x}_{n}} {( 1 + {( f ( u ) )}^{2} )}^{- \frac{3}{2}} . {Grad ( f ( u ) )}_{j} . {Grad ( f ( u ) )}_{i} . {( κ ( u ) )}^{2} . du + \\ {\int }_{{x}_{1}}^{{x}_{n}} {( 1 + {( f ( u ) )}^{2} )}^{- \frac{1}{2}} . {H ( f ( u ) )}_{ij} . {( κ ( u ) )}^{2} . du + \\ {\int }_{{x}_{1}}^{{x}_{n}} \sqrt{( 1 + {( f ( u ) )}^{2} )} . {H ( {κ ( u )}^{2} )}_{ij} du\end{matrix} )\end{matrix}$$

This algorithm may be implemented by the processing unit 12.

### Appendix 2: Variable Metric Method

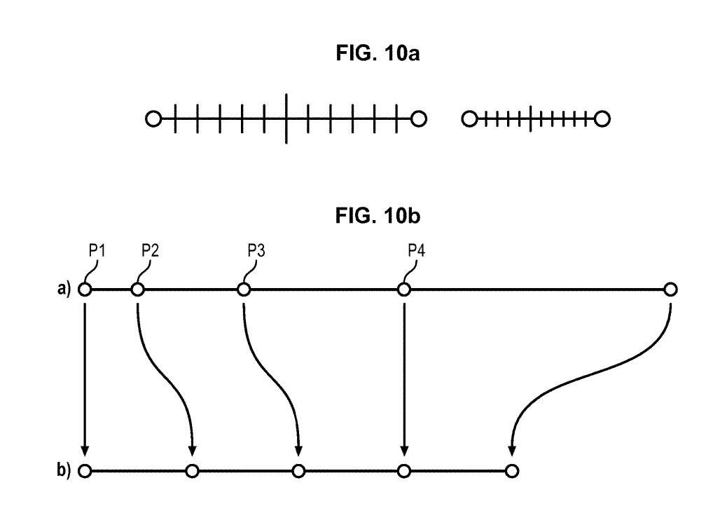

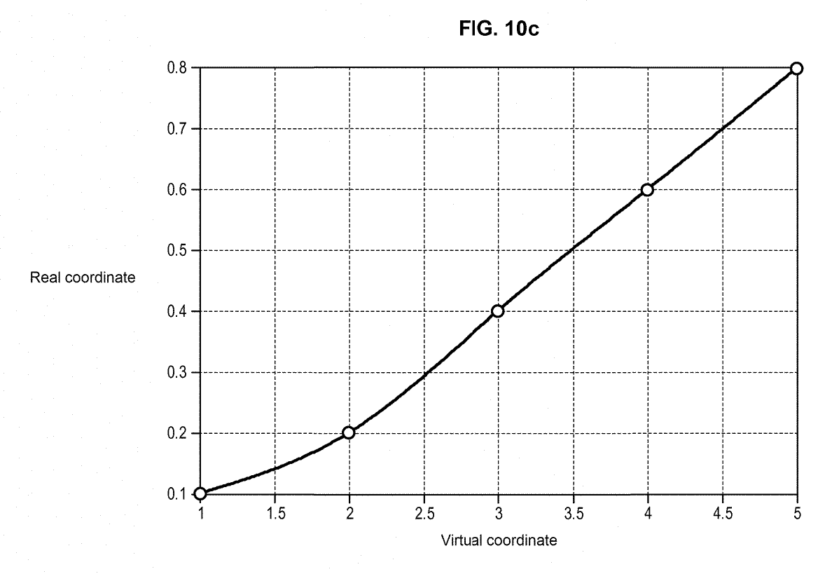

FIG. 10a illustrates the points of the front with different propagation increments. It is noted that the distance between the same two points of the front is not constant between two increments, which means that the length scale associated with each element is different. This is then referred to as different metrics.

The fact of having elements with different metrics (therefore discontinuous at the point of intersection) while imposing a regularity connection C2 between the elements leads to numerical instabilities.

Another point of view consists in saying that the elements do not have the same contributions to the functional (as the result of their different dimensions) while they all convey the same amount of information. Whatever the point of view, this may induce a numerical bias has to be suitably addressed.

To resolve this problem, it is sufficient to utilize a virtual representation space in which the interpolation elements all have the same dimensions. For example, if the discretized crack lengths are x∈{0,1; 0,2; 0,4; 0,6; 0,8}, then xᵥᵢᵣₜᵤₐₗ∈{1; 2; 3; 4; 5; 6; 7; 8; 9; 10; 11} will be taken.

For passing from virtual representation to real representation, a bijection is used between the two reference frames (see FIG. 10b).

The same interpolation functions are used as before. The correspondence between the two representation spaces is implemented by imposing the degrees of freedom f₁₁^{j} and f₁₁^{j+1}=f₂₁^{j} on each node. Then, in order to have a metric that evolves in a “soft” way between each element, the method described previously is implemented. This allows a smooth correspondence to be obtained between the two representation spaces as represented in FIG. 10c.

### REFERENCES

[1] Bueckner H G Z (1970), “A novel principle for the computation of stress intensity factors”, Angew, Math. Mech., Vol. 50, p. 529-546.
[2] Rice J. R. (1972), “Some remarks on elastic crack-tip stress fields”, Int. J. Solids and Structures, 8, 751-758.
[3] Rice J. R. (1989), “Weight function theory for three-dimensional elastic crack analysis”, Fracture Mechanics: Perspectives and Directions (Twentieth Symposium), ASTM STP 1020, R. P. Wei and R. P. Gangloff, Eds., American Society for Testing and Materials, Philadelphia, pp. 29-57.
[4] V. Lazarus (1997), “Some three-dimensional problems of the mechanics of brittle fracture”, Thesis, University of Paris 6.
[5] W. Elber. “The significance of fatigue crack closure”. ASTM STP, 486: 230-242, 1971.
[6] PC. Paris, F. Erdogan, 1963, “A critical analysis of crack propagation laws”. J Basic Eng 85, pp 528-534.
[7] “NASGRO—Fracture Mechanics and Fatigue Crack Growth Analysis Software—Reference Manual”, Version 6.2, 2011.

1. A method for estimating (100) the stress intensity factor in a numerically modeled part, within the context of a fatigue crack propagation model, implemented by a system (10) comprising a data processing unit (12), the method for estimating (100) comprising the following steps:
(E2): obtaining from a numerical model of the part to be analyzed (20), a plurality of values simulated at different points of the part to be analyzed (20),
said plurality of simulated values comprising, for different simulated propagation increments a three-dimensional crack which appears on the numerical model of the part, a set of simulated values of the stress intensity factor at associated points, the position of these points, and data relating to the cracked surface of the crack,
(E3): determining, for each propagation increment and for the set of simulated values therefor, a converted amplitude value of the equivalent global effective stress intensity factor corresponding to that of a plane crack with a straight front and a converted length of the equivalent crack considered, said converted values being determined by equalizing the energy dissipated in the three-dimensional crack of the numerical model and the energy dissipated in the crack of a standard model of a plane crack with a straight front, the energies themselves being determined according to the stress intensity factors,
(E4): Interpolating converted amplitude values of equivalent global effective stress intensity factor between two successive converted crack lengths,
(E5): Storing the converted amplitude values of equivalent global effective stress intensity factor thus interpolated with the associated crack lengths.

2. The method for estimating as claimed in claim 1, wherein the interpolation step (E4) implements a piecewise linear interpolation.

3. The method for estimating as claimed in claim 1, wherein the interpolation step (E4) implements an interpolation by curvature energy minimization.

4. The method for estimating as claimed in claim 1, wherein the interpolation step (E4) comprises the following substeps:
(E41) interpolation using a linear interpolation,
(E42) interpolation using an interpolation by curvature energy minimization, the two interpolations being interchangeable,
(E43) calculation of at least one magnitude representative of a difference in amplitude values of the equivalent global effective stress intensity factor between the two interpolations, said difference being calculated strictly between two values of lengths of the crack corresponding to two successive increments,
(E44) comparison of said magnitude representative of the difference with a predetermined threshold,
(E45) if the magnitude representative of the difference is above the threshold, generation of an instruction to calculate from the numerical simulation of the part to be analyzed (10) stress intensity factor values and values of the position of the crack, between the two successive increments.

5. The method for estimating as claimed in claim 1, comprising, prior to the step of obtaining (E2), a step of calculating (E1) implementing the finite element simulation at successive increments of the evolution of the crack in the part to be analyzed (10), said simulation being performed by the processing unit (12).

6. The method for estimating as claimed in claim 1, wherein the numerical data retrieved in the step of obtaining (E2) the data are obtained by a finite element or extended finite element simulation.

7. The method for estimating as claimed in claim 1, wherein, for the step of determining (E3),
a first data subset makes it possible to find the effective amplitude of the energy release rate ΔG via the following relationships and their equivalence in terms of amplitude:
$$G = \frac{1}{{E}^{*}} ( {K}_{I}^{2} + {K}_{II}^{2} ) + \frac{1}{μ} {K}_{III}^{2}$$
$${E}^{*} = E in plane stresses$$
$${E}^{*} = E ( 1 - {υ}^{2} ) in plane strains$$
$${( Δ {K}_{eff} ( s ) )}^{2} = Δ {G}_{eff} ( s ) . {E}^{*}$$
Where K_{I}, K_{II} and K_{III} are the stress intensity factor SIF coefficients corresponding to the crack opening, plane shear and anti-plane shear modes, respectively, ΔK_{eff}(s) is the amplitude of the effective stress intensity factor, ΔG_{eff} is the amplitude of the effective energy release rate, s is the curvilinear abscissa along the crack front, E is Young's modulus, E* is the equivalent Young's modulus, μ is the shear modulus, v is Poisson's ratio,
a second data subset makes it possible to find the cracked surface increment dSurf, these formulations make it possible to obtain the value of the dissipated energy:
Dissipated energy=∫_{crack front}ΔG_{eff}(S)·dSurf(s)·dl
wherein this dissipated energy is equalized with the dissipated energy of the crack of a standard model of plane crack with a straight front, being expressed in the form:
Dissipated energy^{glob}=ΔF_{eff}^{glob}·dSurf^{glob}·L_{front}
Where the notation glob relates to this standard model, and L_{front} is the length of the crack front,
wherein, thanks to modeling using a Paris law with the Elber crack closure parameters, the link is made between dSurf^{glob} and ΔG_{eff}^{glob}
$$\frac{{dSurf}^{glob}}{dN} = C . {( \sqrt{Δ {G}_{eff}^{glob} . {E}^{*}} )}^{n}$$
where C and n are Paris coefficients,
wherein, by equalizing the two dissipated energies, the following is obtained
$$Δ {G}_{eff}^{glob} = {( \frac{{\int }_{crack front} Δ {G}_{eff} ( s ) . dSurf ( s ) . dl}{C . {( {E}^{*} )}^{n} {L}_{front}} )}^{\frac{1}{n + 1}} = {( \frac{Dissipated energy}{C . {( {E}^{*} )}^{n} {L}_{front}} )}^{\frac{1}{n + 1}}$$
wherein, by means of the relationships between ΔGeff and ΔKeff, ΔK_{eff}^{glob} is determined and wherein Surf^{glob} is determined, i.e. the converted length of the equivalent crack, wherein the first data subset contains the stress intensity factor values at associated points on the crack front and their respective associated position, and the second data subset contains the data relating to the cracked surface.

8. (canceled)

9. A method for evaluating (200) the service life of a numerically modeled part (20), wherein a calculation is implemented of the service life of the part (20) involving the converted amplitude values of effective stress intensity factor interpolated according to the method of claim 1.

10. A system comprising a processing unit (12) comprising calculation means (14) and a memory (16), the unit being configured for implementing the method for estimating according to claim 1.

11. A computer program product configured for being implemented by a system, and comprising instructions for bringing about the implementation of the method for estimating as claimed in claim 1.
